(19) United States
(12) Patent Application Publication
(10) Pub. No.: US 2012/0183346 A1
(43) Pub. Date: Jul. 19, 2012

(54) JOINING ARRANGEMENT WITH ADJUSTMENT OPTION

(75) Inventors: Tayyab Khan, Westland, MI (US); Ralf Schmidt, Oelde (DE); Krishna R. Chellemella, Troy, MI (US); Dirk Kersting, Lippstadt (DE); Guido Opperbeck, Lippstadt (DE)

(73) Assignee: HBPO GMBH, Lippstadt (DE)

(21) Appl. No.: 13/319,192

(22) PCT Filed: Apr. 12, 2010
(86) PCT No.: PCT/EP2010/054776

§ 371 Date: Mar. 7, 2012

(30) Foreign Application Priority Data
May 5, 2009 (DE) 10 2009 019 730.3
Feb. 3, 2010 (EP) PCT/EP2010/051325

(51) Int. Cl. B62D 27/02; F16B 11/00

(52) U.S. Cl. 403/265

(57) ABSTRACT

The present invention relates to a joining arrangement for joining joining partners of a vehicle, including a first joining partner and at least one second joining partner wherein a holding device is provided that serves for connecting the joining partners in order to form the joining arrangement, where the holding device has a receiving structure at which at least one adhesive element is arranged that can be brought into at least two states, where in a first state the adhesive element allows for adjusting the second joining partner to the first joining partner and where a transition from the first state to a second state can be effected by a transformation means, where in the second state the adhesive element is cured, whereby the joining partners can be fixed to each other.

### TECHNICAL FIELD

The present invention involves a joining arrangement for joining joining partners of a vehicle comprising a first joining partner and at least one second joining partner, wherein a holding device is provided that serves for connecting the joining partners in order to form a joining arrangement.

### BACKGROUND

A front module of vehicles bearing an assembly carrier being mounted to the carriage of the vehicle is know from DE 10 2007 016 925 A1. Further an illumination device is arranged at an assembly carrier, whereas the mounting of the illumination device occurs via a holding device, in particular via a holding base. Therewith the assembly carrier is providing the first joining partner and the illumination device is providing the second joining partner. The holding base, forming the holding device, can be placed between a preliminary assembly position and a final assembly position. In order to adjusting existing tolerances during the assembly of the assembly carrier at the vehicle, an according adjustment of the illumination device at the assembly carrier is required. After the illumination device of the vehicle has been adjusted for the given contouring to the neighboring carriage, a final fixation of the illumination device occurs using fixing means, in particular a bolted assembly, whereby a substantial complexity of assembling, in particular a significant complexity of adjustment, arises.

### BRIEF SUMMARY

The invention provides a joining arrangement to join joining partners of a vehicle, with a reduced complexity of assembling, in particular a reduced complexity of adjusting two joining partners of a vehicle to one another.

According to the invention it is intended that the holding device bears a receiving composition comprising at least one adhesive element which is at least convertible into two different states. In the first state the adhesive element enables an adjustment of the second joining partner to the first joining partner, whereby an exchange from the first to the second state can be activated by a means. In the second state however the adhesive element is cured whereby a fixation of the joining partners to one another can be achieved.

The basic of the invention comprises the joining partners which are attached to one another or attached to the vehicle respectively, whereas simultaneously it is ensured that the joining partners exhibit a specified contouring relative to one another or relative to a neighboring carriage of the vehicle. Due to the adhesive element being arranged at the receiving composition and allowing an adjustment of at least one joining partner in its first state a reliable and safe positioning of the joining partner at the vehicle or the joining partners among one another is ensured. In the first state of the adhesive element the receiving composition is in its preliminary assembly position in which the joining partner can be aligned according to the neighboring carriage of the vehicle, for example the car wing or the bonnet, etc.

Has an appropriate adjustment of the illumination device been carried out by a workman, a modification from the first to the second state is activated via means. By this change of conditions the adhesive element cures. At this the receiving composition is already in its final assembly position. The joining partner at the vehicle or the joining partners among themselves has reached a or rather its final position, which matches the reference position, if the adhesive element has reached its cured state, meaning if the adhesive element has reached its second condition. Hence, a final fixation of the joining partners is achieved in a simple way.

It may be useful if the means are accomplished as external means. The external means can be carried out as energy, which activates the modification from the first to the second state based on a variation of the environmental condition. This may occur e.g. through access of light, sound, humidity or exclusion from atmospheric oxygen. The external means may be composed of chemical means, in particular fluids, and/or electrical means and/or mechanical means and/or airborne contact and/or means in terms of energy supply, in particular thermal energy to raise the temperature of the adhesive element, brought in preferably from external heat transmission and/or from electromagnetic radiation, especially energy from light, and/or from sound energy, especially from ultrasonic sound, and/or from microwaves and/or from induction. Adhesives being transferred from a first to a second state through the insertion of energy are basically known. If energy is inserted into the mass of adhesive a curing of the adhesive may occur and both joining partners are fixed to one another.

A possible transformation of an adhesive from its second back to its first state using the same or different means, in particular external means, is particularly known and can be used advantageously. It is e.g. possible that after a fixation of the joining partners to one another a state of the adhesive can be achieved in which both joining partners can be readjusted.

It is in particular advantageously that the modification from the first to the second state occurs with a minimal effort. Is the first joining partner already in its desired adjusting position, there is no further need for a workman to fix the first joining partner to the second joining partner via e.g. mechanical fixing means, like bolts etc. The adhesive element solely needs to achieve its second state, whereas the adhesive element is nearly cured in the second state and therefore the final fixation of the illumination device at the assembly carrier is assured.

In an advantageous further embodiment of the invention the means can involve an induction coil unit which enables a thermal insertion in the adhesive element and which is designed to an extend that it forms an operative connection with the holding device. The induction coil unit can preferably be designed in a circular, bracket- or U-shaped way and can manually or automatically be placed in a position in which the induction coil unit is at least partially enclosing the holding device. To match the circular, bracket- or U-shaped induction coil unit the holding device may be formed in a cylindrical way. If the induction coil unit is surrounding the holding device, an adequate supply of current to the induction coil unit can generate an electrical current flow in an electrically conducting component of the receiving composition. Using this electrical current flow a heat development can be achieved transforming the adhesive element from its first to its second state. The induction coil unit is brought into contact with the receiving composition and is not activated until the joining partners are adjusted to one another. Following the transformation of the state, the adhesive element is cured and the assembly of the joining partners to one another is fixed. The induction coil unit can either manually be brought in an operative connection with the holding device although the holding device can exhibit a manually not accessible position, e.g. between a front end module and the frame of the vehicle or between an illumination device and an assembly carrier, so that a device may serve to bring the induction coil unit into an operative connection with the holding device. The induction coil unit can alternatively be permanently connected with the holding device. It is appreciated that the induction coil unit is singularly injected with a current to achieve the modification of states of the adhesive element. For the following durable application of the holding device, positioned between the joining partners, the induction coil unit remains at the holding device, whereby the induction coil unit is continuatively a construction part of the holding device.

Advantageously the geometry of the adhesive element can be adapted to the receiving composition in particular building a cavity in which the cavity-adapted adhesive element is incorporated whereas the adhesive element is viscous in its first state. During the adjustment of the two joining partners to one another in the first state of the adhesive element it is malleably deformable. Is the desired final assembly position reached after adjusting the joining members to one another the subsequent activation of the modification of states of the adhesive element takes place. The adhesive element is not necessarily inherently stable but can be of a gel- or a jelly-like consistency. The cavity in the receiving composition is incorporating the adhesive element which advantageously is filling-out the cavity.

The adhesive element can be composed of Hotmelt, in particular a reactive Hotmelt, and/or of encapsulated polyurethan and/or of epoxide adhesive and/or of acrylate adhesive. In particular the receiving composition may be of multi parts, whereas at least a first part of the receiving composition is arranged at the first joining partner and a second part of the receiving composition is arranged at the second joining partner and/or is integrally formed and/or is composed of itself, respectively. The cavity of the adhesive element is sectionally narrowed through the first part and the second part of the receiving composition. As long as the adhesive element is in its first, viscous state both parts of the receiving composition may be shifted against one another. Is the adhesive element and a modification into the cured state activated, both parts of the receiving composition are fixed to one another.

Continuatively it is conceivable to trigger a modification of the adhesive element into the second state via internal means. At this the adhesive element can possess at least two chambers or both chambers build one cavity, whereas in the first chamber a first component and in the second chamber a second component of the adhesive resides. Advantageously a barrier all element is intended which separates the chambers in the inactivated state of the adhesive element and upon activation the barrier element is movable enabling the mixing of the first and the second component of the adhesive, whereas the barrier element is movably mounted in particular to the adhesive element and can be activated using a defined external area. The barrier element may e.g. be movably mounted to the adhesive element and may be turned into its operative position using a defined external area. Advantageously both components comprise monomers defining the basic molecules of the polymer developing during the mixture. One of both components can e.g. comprise resin monomers or binding agents, while the other component comprises a curing agent. Further ingredients of the components may be stabilizers, thixotropic agents, mediators, further additives, and/or dyes or filler media. The barrier element may be a membrane, which admits a mixture of both components after the final assembly.

With a notable advantage the joining arrangement is formed for joining preventilated assembly groups of a vehicle, in particular of a front module, of a rear end module, of a hatch door, of a door module and/or of a bumper, in particular a cover of a bumper at a carriage of a vehicle, an illumination device with or at an assembly carrier and/or a cockpit device of a vehicle. According to the present invention, the joining arrangement for joining preventilated assembly groups of a vehicle is basically advantageously applicable if the assembly group comprises components which need an exact arrangement to one another or the assembly group needs an exact arrangement towards the carriage structure of the vehicle to e.g. maintain clearances. If an illumination device in a front module, in particular a headlight, and is the front module via the assembly carrier fixed to the carriage, the headlight maintains clearances with the carriage or other interfaces, which need to be kept exactly. A summation of dimensional tolerances develops from multiple sequent components mounted to one another, leading to the advantage of a possible adjustment of assembly groups using the holding device according to the present invention and the therein affiliated adhesive element without the necessity to manually reach the holding device and the adhesive element. A single adjustment position of the assembly groups may be “frozen up” if, according to the present invention, external means, e.g. induction coil units, are used to transform the adhesive element from its first to its second state. The external means activating the transformation of states of the adhesive element may be accomplished in a way that a workman does not need to arrange an adjustment position simultaneously to activate the transformation of states of the adhesive element at a time. The external means may cover e.g. a time-dependent activation of an activation due to mechanic influence or the insertion of energy, whose activation may be regulated via a easy-to-operate control element, e.g. a foot-switch.

According to an advantageous embodiment the first part of the receiving composition may be a casing and/or the second part of the receiving composition may be formed as a rod-shaped element, whereas the rod-shaped element extends its head piece into the casing so that the cavity extends to the acceptance of the adhesive element, in particular as a circular structure between the head piece and the casing. The rod-shaped element comprises preferably an elongated extension correlating approximately to the line of symmetry of the cylindrical holding device. The head piece may be formed as a spherical segment and/or as a disc-like section and/or as a cuboid segment and/or as a mushroom-shaped segment and possesses at least one rear intersection area to in particular enlarge the adhesive contact area between the adhesive element and the rod-shaped element. Additionally a form-closed contact between the cured adhesive element and the head piece is build. The rod-shaped element extends itself partially into the casing if the rod-shaped element is inserted into the casing, particularly surrounding the head piece inside the casing. Thereby a radial space is intended between the rod-shaped element and the inside of the casing, which is providing the space for the way of adjusting if the first joining partner, at which the rod-shaped element is arranged, is located at the opposite of the second joining partner, at which the casing is arranged, in any axis in the range of six variances. Thereby the location of the rod-shaped element in the casing can be varied, whereby the location of the rod-shaped element is fixed behind the adjustment in the casing due to a transformation of states of the adhesive element to its cured state. The head piece may adopt any geometry to form an as large as possible contact area with the adhesive element. Further a rear intersection area is generated to enlarge the maximal holding force between the rod-shaped element and the casing. Continuatively the head piece may possess ribs, recesses, pits or elevated areas to enlarge the contact area and build a rear intersection area.

The casing may in an advantageous embodiment be formed as a clips-casing, whereby a casing element is intended, designed as a clips-casing. The clips-element is mounted to the clips-casing using a clips-assembly to preassemble the rod-shaped element in the casing. Using a preassembly the adhesive element simultaneously inserts between the rod-shapes element and the casing and preassembles both parts. A sealing element is intended particularly building a cavity for accepting the elastic part of the adhesive element, whereas the sealing element is assembled at the casing element and/or at the rod-shaped element. After preassembling the holding device the adhesive element is in its first state being basically enclosed. The sealing element may be of a collar-like form being elastic and allowing a displacement of the rod-shaped element in the casing if the adjustment has occurred. Due to the clips-assembly of the casing element the rod-shaped element may be attached to the casing leading to a retaining of the first joining partner to the second joining partner by accepting at least the self-weight of one of the joining partners to the holding device, which may exist several times between the joining partners, in particular three times.

The casing element may comprise an assembling help, particularly shaped as a geometric recess which at least interferes with one present mounted molding recess if the casing element is arranged at the casing. Therefore the casing element can only be mounted in one exact position above the casing in which the clips-assembly is possible, leading to an advantage if the holding device needs to be mounted at a position out of sight of the workman or at the vehicle. By way of example the assembly of the second joining partner at the first joining partner only occurs if at the same time the parts of the receiving composition are joint against one another. The first part of the receiving composition can be preassembled at the first joining partner whereby the second part of the receiving composition is already present. The parts of the receiving composition are assembled if the joining partners are arranged to one another, meaning the rod-shaped element in the casing. The assembling aid offers an ease if the assembly takes place in a for a workman non-visible area whereby the workman afterwards needs to place the casing element above the casing. The assembly aid may have the shape of notches in the casing element, whereby the casing presents provisions with which the notches interfere. The clips-assembly takes places as soon as the casing element is in the correct pivot position above the casing.

According to another advantageous embodiment the casing may be formed as a bayonet-casing and the casing element as a bayonet-element, whereby the bayonet-element is assembled at the bayonet-casing using a bayonet-conjunction, to such an extent that the preassembly of the rod-shaped element takes place in or at the casing. The bayonet-conjunction initially demands an axial joining of the casing element to the casing whereby an adjacent rotation occurs in a certain angle.

Following another advantageous embodiment the casing may be a screw-socket and the casing element may be a screw-element whereby the screw-element can be assembled at the screw-socket using a screwing in a way that the preassembly of the rod-element occurs in the casing.

The rod-shaped element may comprise an assembly part, which is preferably designed as a press-collar to press the rod-shaped element against a recessed area of the second joining partner to build a form-closed interaction whereby a screw-element is intended which is screwed at or in the rod-shaped element. The press-collar may build a saucer-shaped provision at the rod-shaped element whereby at least the outer perimeter comprises a structure, e.g. an axial knurl. If the saucer-shaped provision is pushed into a recessed area at the second joining partner the screw-element may be used as a casing to press the press-collar into the recess at the second joining partner and keep it in the recess. The structure at the outer perimeter of the press-collar causes a simultaneous rotation of the rod-shaped element to screw the screw-element advantageously onto the thread section of the rod-shaped at a for the workman accessible position, to connect the rod-shaped element with the second joining partner.

According to another advantageous embodiment of the invention, the holding device may provide a heating-element to build a means for changing the states of the adhesive element, which particularly may be arranged in the casing and/or in the rod-shaped element and which is accomplished to heat the adhesive element in a way that the heating-element is providing a or the means to activate the transformation from the first to the second state of the adhesive element. The heating-element may be shaped as a heated filament and may comprise coil-like twists, which extend in the casing or in the rod-shaped element around the axis of symmetry. To electrically connect the heating-element connecting cables may conduct out of the heating-element.

According to another embodiment the heating-element which is arranged at and/or in the adhesive element itself or at least at the cavity and which is accomplished to heat the adhesive element in a way that the heating-element builds a or the means to activate the transformation from the first to the second state of the adhesive element. A heating-element may further be intended in the adhesive element itself or in the casing and/or in the rod-shaped element.

According to another possible embodiment the adhesive element may be build from an electrical conducting material. This electric conducting material may comprise a specific resistance offering a magnitude which is determined in a way that by establishing a voltage between the electrical conducting casing and the electrical conducting rod-shaped element an according decay of voltage in the adhesive element occurs. In this way a heat development is caused in the adhesive element leading to a transformation of states of the adhesive element from viscous to cure. Advantageously an electrical adaptor between the casing and the rod-shaped element is arranged without the necessity of a heating-element in the holding device or in the adhesive element. Moreover a heat development can be generated by using the induction coil unit which induces eddy currents in the induction coil unit in the adhesive element.

### BRIEF DESCRIPTION OF THE DRAWINGS

Further embodiment-improving provisions are given below in conjunction with preferred embodiments of the invention. It is shown in a schematic representation:

FIG. 1 an assembly carrier to build a first joining partner with connecting links which is attached to the illumination device and a second joining partner, whose illumination device is not shown,

FIG. 2 a detail view of the assembly of the second joining partner at the first joining partner and of a holding device between the joining partners,

FIG. 3 a first embodiment of a holding device according to the present invention in an disassembled state,

FIG. 4 the embodiment according to FIG. 3 in an assembled state,

FIG. 5 the assembly of an induction coil unit at the holding device according to the embodiment in FIG. 3 and FIG. 4,

FIG. 6a the assembly of an induction coil unit at the holding device in a cross section view,

FIG. 6b the assembly of the heating element in the casing of the holding device,

FIG. 6c the assembly of the heating-element in the adhesive element between the casing and the rod-shaped element,

FIG. 7 a second embodiment of a holding device in a disassembled state,

FIG. 8 the embodiment of the holding device according to FIG. 7 in an assembled state,

FIG. 9 the embodiment of the holding device according to FIG. 7, whereby the rod-shaped element shows another embodiment,

FIG. 10 another embodiment of the holding device in a disassembled state and

FIG. 11 the embodiment of the holding device according to FIG. 10 in an assembled state.

### DETAILED DESCRIPTION

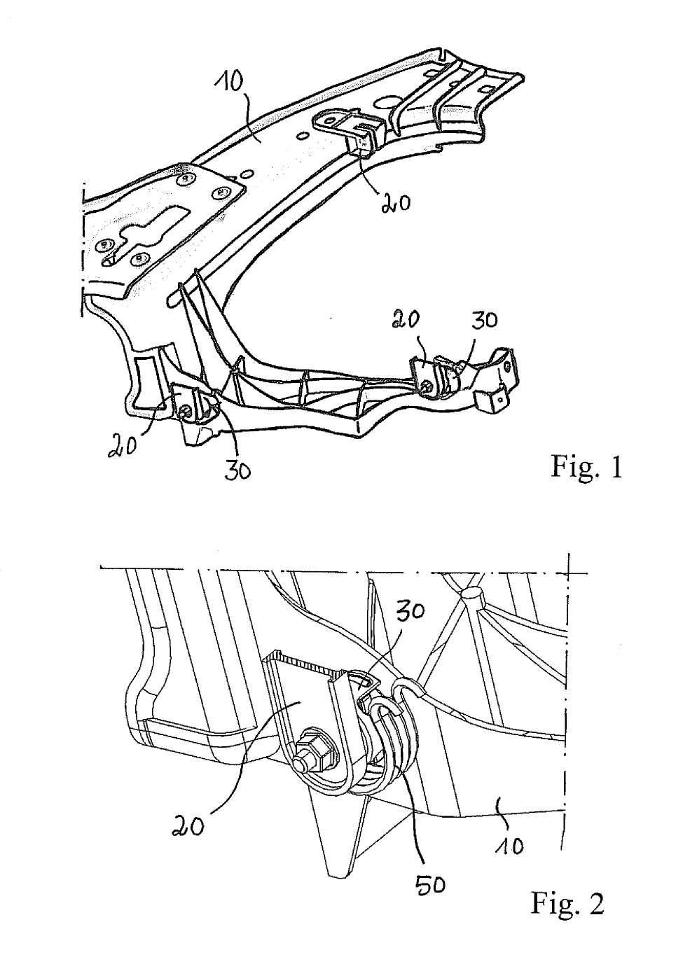

FIG. 1 illustrates an assembly carrier 10 representing a first joining partner 10 in a perspective view. The assembly carrier 10 generates the framework of a front module of a vehicle, at which e.g. an illumination device, not shown in the view, is arranged. The illumination device exhibits multiple connecting links, building the second joining partner 20 in this exemplary embodiment. In order to arrange the second joining partner 20 at the assembly carrier 10, three holding devices 30 serve as an exemplary joining arrangement. Two joining links for building the second joining partner 20 are shown at the rear side of the assembly carrier 10, whereas the subsequent FIG. 2 is illustrating one of the joining arrangements.

In FIG. 2 a part of the assembly carrier 10 is shown in detail, at which a second joining partner 20 is assembled, e.g. as a connecting link of an illumination device 20. A holding device 30 according to the invention serves as a configuration between the first joining partner 10 and the second joining partner 20. The holding device 30 in achieved in a cylindrical way and comprises an adhesive element in a not precisely defined way. This adhesive element is at least transformable into two states, whereby in a first state the adhesive element enables an adjustment of the second joining partner 20 at the first joining partner 10, and by using means the transformation from the first to the second state can be activated, whereby the adhesive element is cured in its second state, achieving a fixation of the joining partners 10 and 20 to one another.

An induction coil unit 50 is illustrated as an exemplary means to transform the state of the adhesive element. The induction coil unit 50 is encapsulating the holding device 30 in a U-shaped way, and a heat development within the holding device 30 occurs upon electromagnetic coupling with another induction element by applying an induced voltage in the induction coil 50, whereby the heat development acts on the adhesive element or it occurs in the adhesive element itself. Due to the heat development the adhesive element is transformed from the viscous to the cured state, and the second joining partner 20 is fixed to the first joining partner 10 in stationary and in a stable position using an according adjustment.

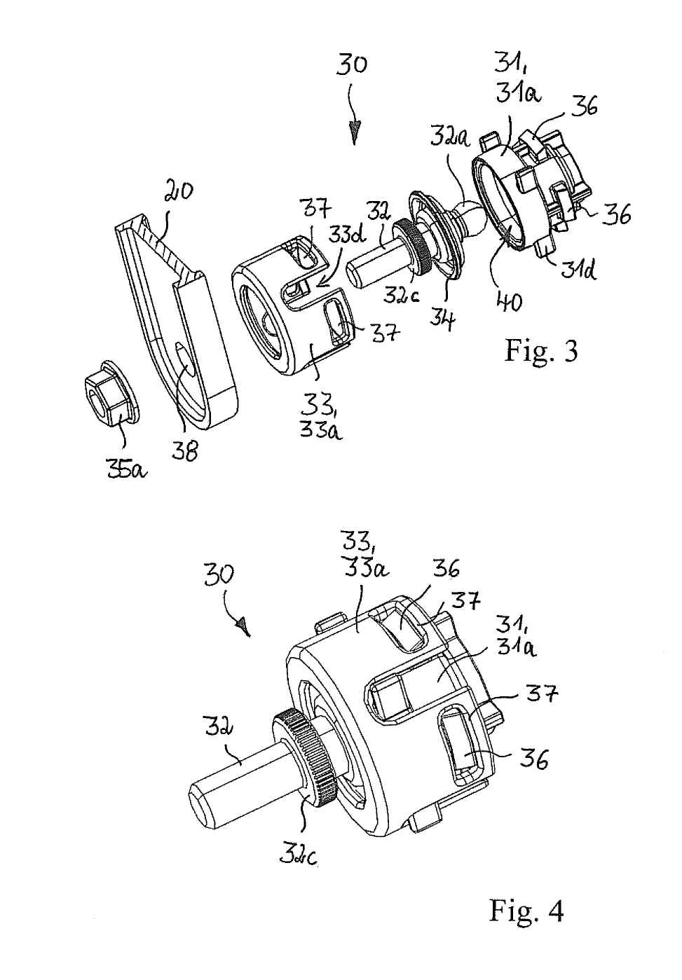

FIGS. 3 and 4 present a first embodiment of the holding device 30, in a dismantled, flying view in FIG. 3 and in a mounted state in FIG. 4. The holding device 30 comprises a first part of the receiving composition 31, which is formed as a casing 31, and a second part of the receiving composition 32, which is exhibited as a rod-shaped element 32. The casing 31 is formed as a clips-casing 31a and possesses snap-fits 36, which snap in place into snap-openings 37, inserted in a casing element 33, whereby the casing element 33 is shaped as a clips-element 33a.

The casing 31 may be attached to the first joining partner, whereas the rod-shaped element is mounted to the second joining partner using a screw-element 35a. Therefore the rod-shaped element 32 is initially inserted in the casing 31. Prior to this an adhesive element 40 (not shown in detail) is brought into the interior zone of the casing 31. The rod-shaped element 32 with a head piece 32a assembles the casing 31 and at the same time dips into the adhesive element 40. In order to completely encapsulate the adhesive element 40 a sealing-element 34 is attached to the rod-shaped element 32 in a collar-shaped way. The sealing-element 34 is rounded off with the opening of the casing 31 in its mounted state, as the adhesive element 40 is completely enclosed between the rod-shaped element 32 and the casing 31. Subsequently the casing element 33, being shaped as a clips-element 33a, can be clipsed into the clips-casing 31a, as the snap-fits 36 can snap in place into the snap-opening 37.

In order to assure the correct position of the clips-element 33a at the clips-casing 31a, the clips-casing 31a comprises an assembling provision 31d fitting into geometric recesses 33d within the clips-casing 31d. The holding device 30 in its assembled state is shown in FIG. 4, in which the clips-element 33 is already mounted to the clips-casing 31a. In this state only the rod-shaped element 32 protrudes from its holding device 30, which is penetrating through an opening 38 within the second joining partner 20 and is screwed onto the screw-element 35a. Thereby the press-collar 32c, being assembled to the rod-shaped element 32 in a saucer-shaped manner, actuates into a recess, which is located on the rear side of the second joining partner 20 surrounding the opening 38.

The press-collar 38 comprises a knurled skin surface, whereby the knurl geometry is pressed into the second joining partner 20 in a way that the screw-element 35a is screwable onto the rod-shaped element 32 without co-rotating with the rod-shaped element 32. Contrary to the described order the rod-shaped element 32 can first of all be mounted to the second joining partner 20 to afterwards insert the rod-shaped element 32 with its head piece 32a into the clips-casing 31a to subsequently clips the clips-element 33a to the clips-casing 31a. Afterwards the second joining partner 20 is adjusted relative to the first joining partner (not shown, but permanently fixed to the casing 31). Subsequently a transformation of states of the adhesive element 40 occurs as the rod-shaped element 32 is forming a rigid connection to the casing 31 and therewith to the first joining partner.

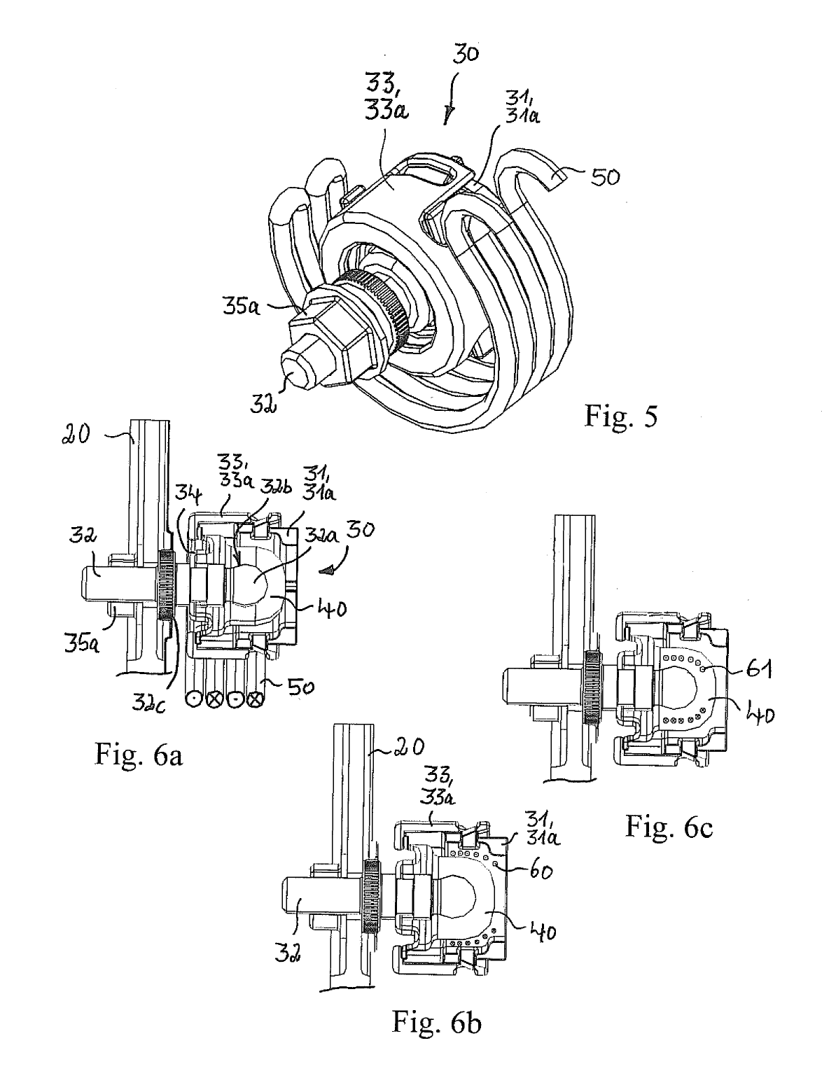

In FIG. 5 an embodiment of a holding device 30 in its assembled state is illustrated, in which the casing element 33 in shape of a clips-element 33a is already clipsed to the casing 31 in shape of a clips-casing 31a. Accordingly, the rod-shaped element 32, shown with the screw-element 35a, protrudes out of the holding device 30, at which the second joining partner 20 can be assembled. In this state, in which the rod-shaped element 32 is already adjusted relative to the casing 31, the adhesive element 40 needs to be transformed in its cured state. Hereunto an induction coil unit 50 is shown. It is designed in a bracket-, U-shaped manner and almost completely encloses the holding device 30. The induction coil unit 50 exhibits electric cables of a meandering course, which comprises two connecting ends connectable to an adequate current of an induction current generator. Using an induction current an electromagnetic field is developed which may lead to a heating of the adhesive element 40, in a direct way or via neighboring construction elements like the casing 31 or the rod-shaped element 32.

FIG. 6a shows a sectional arrangement drawing of the assembly of the holding device 30 and the induction coil unit 50 according to FIG. 5. The sectional arrangement illustrates the first part of the receiving composition 31 of the holding device 30 which is achieved as the casing 31 and particularly as the clips-casing 31a. A casing element 33, particularly accomplished as a clips-element 33a, is clipsed on top of the clips-casing 31a. The adhesive element 40 is limited by the interior of the clips-casing 31a and the rod-shaped element 32 with its head piece 32a. The opening of the casing 31 is sealed via a sealing-element 34, completely enclosing the adhesive element 40. The drawing further illustrates a joining arrangement of the rod-shaped element 32 at the second joining partner 20, whereby a press-collar 32c is pressed into a recess within the second joining partner 20. The screw-element 35a is screwed to the spindle section of the rod-shaped element 32, pressing the press-collar 32c into the recess of the second joining partner 20. Is the second joining partner 20 adjusted to the first joining partner 10, which exhibits a permanent joint, the adjusting movement between the rod-shaped element 32 or the head piece 32a respectively and the clips-casing 31a is compensated. Subsequently the induction coil unit 50 is supplied with a current and the adhesive element 40 is heated by the generation of an eddy current in one of the involved assembly parts like the casing 31a, the rod-shaped element 32 or the adhesive element 40 itself and the adhesive element 40 is thus transformed into its second, cured state. Therewith a rigid connection between the second joining partner 20 and the first joining partner, represented by the casing 31, develops.

In order to build a form-closed interaction between the rod-shaped element 32 and the adhesive element 40, the in the adhesive element 40 protruding section of the rod-shaped element 32 comprises a rear intersection area 32b, which is exemplarily shown as the back side of the head piece 32a. Therewith the area of contact between the rod-shaped element 32 and the adhesive element 40 is enlarged.

FIG. 6b is presenting another alternative for a heat input into the adhesive element 40. A heating-element 60 is inserted into the casing 31, built by a clips-casing 31a. This may alternatively be also inserted in the casing element 33, represented by a clips-element 33a, whereby an arrangement of the heating-element 60 in the rod-shaped element 32 is conceivable as well. The heating-element 60 is illustrated in a coiled shape heating through the application of an electric current. To transform the adhesive element 40 in its second, cured state, the heat-generation in the casing 31 is transmitted thereto.

FIG. 6c illustrates an alternative embodiment of the assembly of the heating-element 61 straight within the adhesive element 40. The heating element 61 can in the same manner be formed in a coiled shape 61 and can transmit heat to the adhesive element 40 upon application of an electric current. The coiled shape is generating an ohmic resistance leading to a heating of the heating-element 60 upon a sufficiently large current conduction. The illustrated assembly of the heating-elements 60 and 61 can be formed in a closed coiled shape to build a kind of secondary coiled shape similar to a transformer. An induction tension, leading to a heating, is generated in the heating-elements 60, 61, arranged as closed coils, if the induction coil unit 50 is arranged and supplied with a current. Therewith the advantage is achieved that neither circuit points from the holding device 30 nor from the adhesive element 40 must be carried out.

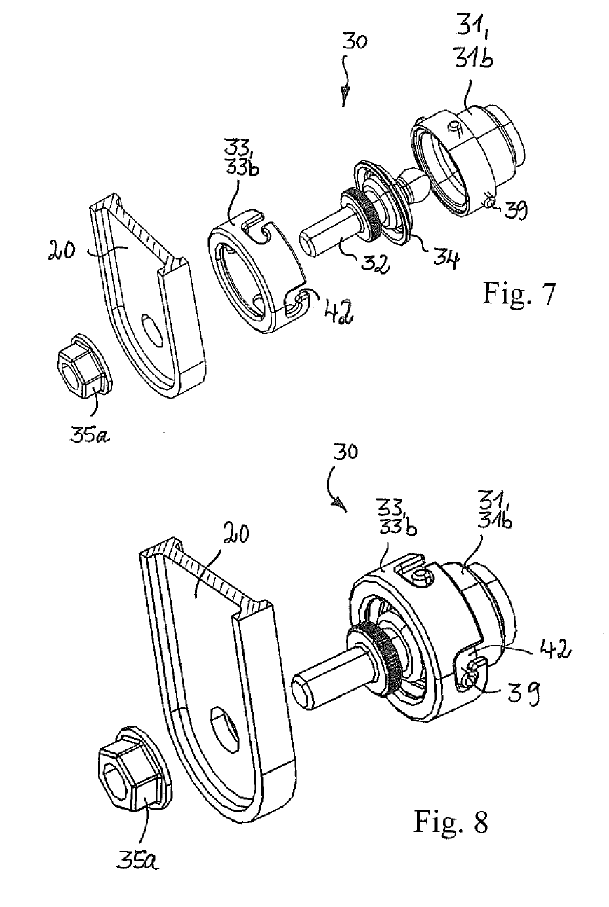

FIGS. 7 and 8 present another embodiment of the holding device 30, in a dismantled, flying view in FIG. 7 and in a mounted state in FIG. 8. The holding device 30 comprises a casing 31 shaped as a bayonet-casing 31b. This can form a bayonet-seal together with a casing element 33, being shaped as a bayonet-element 33b. The bayonet-element 33b can be moved along the line of the axis of symmetry of the holding device 30, composed of the longitudinal extension of the rod-shaped element 32, in the direction of the bayonet-casing 31b. The bayonet-elements 39 thereby attain the bayonet-recess 42 and through a subsequent twisting of the bayonet-element 33b on top of the bayonet-casing 31b a sustained connection is established. The rod-shaped element 32 is fixed to the inner surface of the bayonet-casing 31b, e.g. via the sealing-element 34 at the rod-shaped element 32. The second joining partner 20 can be connected to the rod-shaped element 32 by a subsequent screwing of the screw-element 35 to the spindle-like end of the rod-shaped element 32.

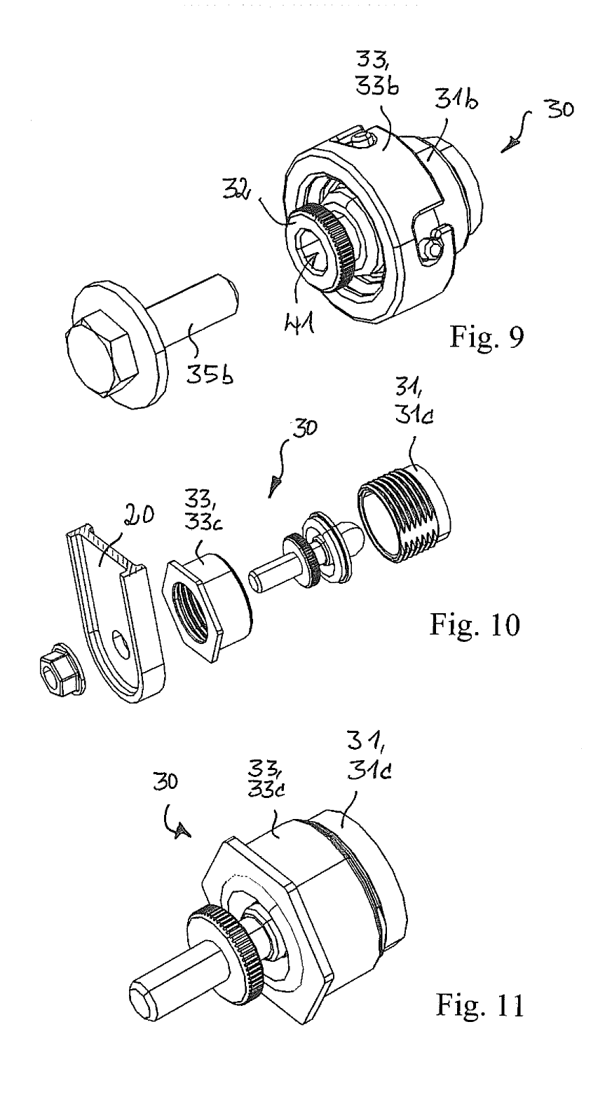

FIG. 9 is illustrating an alternative embodiment of a rod-shaped element 32 comprising a tap hole 41 at its end in which the screw-element 35b is screwable. The shown embodiment of the holding device 30 matches with the bayonet-casing 31b together with a bayonet-element 33b, whereby the specific embodiment of the rod-shaped element 32 comprising a tap hole 41 is suitable for every other represented shape of the holding device 30.

FIG. 10 illustrates another embodiment of the holding device 30 comprising a casing 31 which is shaped as a screw-casing 31c. A screw-element 33c can be screwed to the screw-casing 31c building a casing element 33.

FIG. 11 represents a holding device 30 according to FIG. 10 in its mounted state in which the screw-element 33c is already screwed to the screw-casing 31c.

The invention is not limited to the embodiments described above. More preferably a variety of options is conceivable which exercise the represented solutions in generally different embodiments. Any characteristic and/or advantage mentioned in the claims, the description or the figures, including structural details, spatial arrangements and procedural steps, are substantial for the invention either among themselves or in any combination.

1. Joining arrangement to join joining partners of a vehicle, comprising:
a first joining partner;
at least a second joining partner;
a holding device, by which the joining partners are connectable to one another to form a joining arrangement;
wherein the holding device comprises a receiving composition, at which at least one adhesive element is assembled, where the adhesive element is capable of at least two states,
wherein in a first state, the adhesive element enables an adjustment of the second joining partner at the first joining partner,
wherein via a transformation means, the adhesive element is transformed from the first state to the second state, and
wherein in the second state the adhesive element is cured such that a fixation of the joining partners to one another is achieved.

2. Joining arrangement according to claim 1, wherein the transformation means are external electrical means configured to deliver thermal energy into the adhesive element.

3. Joining arrangement according to claim 1, wherein the transformation means comprise an induction coil unit, which enables a thermal insertion in the adhesive element and is configured to form an operative connection with the holding device.

4. Joining arrangement according to claim 3, wherein the induction coil unit comprises a circular, bracket- or U-shaped shape and can manually or automatically be placed in a position in which the induction coil unit is at least partially enclosing the holding device.

5. Joining arrangement according to claim 1, wherein a geometry of the adhesive element can be adapted to the receiving composition, and wherein the receiving composition delimits a cavity in which the cavity-adapted adhesive element is incorporated, whereas the adhesive element is viscous in the first state.

6. Joining arrangement according to claim 1, wherein the adhesive element comprises a reactive Hotmelt, and/or an encapsulated polyurethan and/or an epoxide adhesive and/or acrylate adhesives.

7. Joining arrangement according to claim 5, wherein the receiving composition is composed of multiple components comprising a first part of the receiving composition is arranged at the first joining partner and a second part of the receiving composition is arranged at the second joining partner and/or the receiving composition is integrally formed.

8. Joining arrangement according to claim 1, wherein the joining arrangement is configured for joining preventilated assembly groups of the vehicle comprising at least one of a front module, a rear end module, a hatch door, a door module, a bumper, in a cover of a bumper at a carriage of the vehicle, an illumination device with or at an assembly carrier, and a cockpit device of the vehicle.

9. Joining arrangement according to claim 7, wherein the first part of the receiving composition is a casing and/or the second part of the receiving composition is formed as a rod-shaped element, whereas the rod-shaped element preferably extends a head piece into the casing, so that the cavity extends for accepting the adhesive element, as a circular structure between the head piece and the casing.

10. Joining arrangement according to claim 9, wherein the head piece may be formed as a spherical segment and/or as a section and/or as a cuboid segment and/or as a mushroom-shaped segment and possesses at least one rear intersection area to enlarge an adhesive contact area between the adhesive element and the rod-shaped element.

11. Joining arrangement according to claim 9, wherein the casing is formed as a clips-casing and a casing element wherein the clips-element is mountable to the clips-casing using a clips-assembly to such an extent that a preassembly of the rod-shaped element in or at the casing occurs.

12. Joining arrangement according to claim 11, wherein the casing is formed as a bayonet-casing and the casing element is formed as bayonet-element, whereby the bayonet-element is assembled at the bayonet-casing using a bayonet-conjunction, in such an extent that the preassembly of the rod-shaped element takes place in or at the casing.

13. Joining arrangement according to claim 11, wherein the casing is shaped as a screw-casing and the casing element is shaped as a screw-element whereby the screw-element can be assembled at the screw-casing using a screwing in a way that the preassembly of the rod-shaped element occurs in the casing.

14. Joining arrangement according to claim 11, wherein the casing element comprises an assembling help shaped as a geometric recess which at least interferes with one present mounted molding recess at the casing if the casing element is arranged at the casing.

15. Joining arrangement according to claim 5, wherein a sealing-element is intended to build the elastic part of the cavity for accepting the adhesive element, whereas the sealing-element is assembled at the casing element and/or at the rod-shaped element.

16. Joining arrangement according to claim 9, wherein the rod-shaped element comprises an assembly part, configured as a press-collar to build a form-closed interaction by pressing the press-collar into an area of the second joining partner, whereby a screw-element is screwed at or in the rod-shaped element.

17. Joining arrangement according to claim 1, wherein the casing and/or the rod-shaped element comprises a heating-element such that the heating-element provides the means to activate the transformation of the adhesive element from the first to the second state.

18. Joining arrangement according to claim 5, wherein a heating-element is provided that is arranged at and/or in the adhesive element or at least at the cavity and which is configured to heat the adhesive element in a way that the heating-element activates the transformation means to transform from the first to the second state of the adhesive element.
